(19) United States
(12) Patent Application Publication
(10) Pub. No.: US 2024/0181410 A1
(43) Pub. Date: Jun. 6, 2024

(54) BEVERAGE ADDITIVE CONTAINER AND STIRRING DEVICE

(71) Applicant: James OSBORNE, Nashville, TN (US)

(72) Inventor: James OSBORNE, Nashville, TN (US)

(21) Appl. No.: 18/526,816

(22) Filed: Dec. 1, 2023

Related U.S. Application Data
(60) Provisional application No. 63/385,753, filed on Dec. 1, 2022.

(51) Int. Cl. B01F 35/71; B01F 23/50; B01F 33/501; B65D 5/42; B65D 5/56; B65D 5/62; B65D 5/70; B65D 65/42

(52) U.S. Cl. CPC B01F 35/7131; B01F 23/56; B01F 33/5011; B65D 5/4295; B65D 5/563; B65D 5/62; B65D 5/708; B65D 65/42; B01F 2101/14

(57) ABSTRACT

A dispensing container having a tubular form which is configured to hold a flowable substance for dispensing, such as into a beverage. The tubular container is intended for use as a stirring device, such that following dispensing of the flowable substance contained therein, the tubular container can be used to stir the beverage to assist in incorporating, diluting, and/or mixing the flowable substance into the beverage.

### CROSS-REFERENCE TO RELATED APPLICATION

This application claims the benefit of U.S. Provisional Patent Application No. 63/385,753 entitled “BEVERAGE ADDITIVE CONTAINER AND STIRRING DEVICE” filed on Dec. 1, 2022, the entire contents of which is incorporated herein by reference in its entirety for all purposes.

### FIELD OF THE INVENTION

The present disclosure is directed to a device for the dispensing and agitating of additives into beverages such as creamer or sugar into coffee or tea.

### BACKGROUND OF THE INVENTION

The use of additives and supplements which are stirred into beverages are as ubiquitous as the consumption of the particular beverages themselves. For instance, certain polls place the percentage of individuals in the United States who enjoy adding sweeteners (such as sugar and sugar substitutes), or flavor additives (such as creamers) at 65% while the balance prefer their coffee without additives or “black”. As such, the prevalence single-use single-serving, referred to herein as “single-serving containers”, have become an assumed mainstay of coffee houses, gas stations, highway rest-stops, restaurants, and even homes. The single-serving additive containers for items such as sugar or creamer enable portioned amounts allowing users to conveniently pour additives into their beverage with limited mess, reduced chance of exposure to germs, increased longevity of the additives, reduced cleanup, and increased ability to carry such additives. For instance, a common bag of sugar in the United States contains one teaspoon (˜5 mL) of sugar, and equal to “one cube” of sugar as referred to in the vernacular. Similarly, a common container containing a single serving of creamer contains approximately one tablespoon of creamer, which is equal to a half-ounce (˜15 mL).

The use of single-serving containers, while convenient, creates excess waste beyond the use of the containers themselves as the single use containers are commonly used in tandem with a stirring device. In certain scenarios such as in a restaurant or home setting, an individual may use a utensil such as a metal spoon to stir their additives into the beverage of choice. However, in most settings, the stirring devices provided are typically a single use stirring device, thus resulting in yet another element which must be disposed of. Stirring devices include plastic stirring devices, and organic stirring sticks such as those manufactured from bamboo or wood-based products.

Accordingly, there is an identified need for a beverage additive container which serves a dual purpose as a container for the additive, as well as a convenient stirring device.

### SUMMARY OF THE INVENTION

It is an aspect of certain embodiments of the present disclosure to provide a tubular beverage additive container which is used to dispense a beverage additive, followed by the use of the container as a stirring device. A “beverage additive” as used herein surrounds a flowable substance which is added to water or a beverage in a powder, liquid, or otherwise flowable form. A beverage additive of certain embodiments includes sugar, sugar substitutes, sweeteners, creamer powder, creamer liquid, flavor additive, electrolyte mix, or instant coffee. However, alternative flowable substances which may be desired to be added to a beverage or water are within the spirit and scope of the present disclosure.

In certain embodiments it is a further aspect of a tubular beverage additive container to comprise at least one aspect adapted for resting on a planar surface without rolling. The anti-rolling aspect in certain embodiments comprises a planar aspect, while alternate embodiments comprising alternate forms which prevent rolling on a flat surface are within the spirit and scope of the present disclosure. Embodiments of an anti-rolling aspect include, but are not limited to, a tubular cross-section with a linear aspect such as a polygon, a regular polygon, a tubular cross-section comprising acute integral angles such as found in a 5-point star shape, a tubular cross-section comprising an elongated form such as an ellipse, or tubular cross section comprising a tubular cross-section having a linear aspect in conjunction with non-linear aspects such as a found in the case of a truncated circle, a circular segment, or a rounded rectangle.

In certain embodiments it is an aspect of the present disclosure to provide a stirring device which maintains its rigid form when used to stir a hot beverage. Existing beverage stirring devices comprise an extruded thermoplastic wherein heat is used to allow the extruding of the material. As a result, the use of a thermoplastic extruded stirring device for a heated beverage such as coffee or tea, will result in the stirring device becoming less rigid and less effective for the stirring to incorporate the beverage additive into the beverage. In certain embodiments of the present disclosure, the additive container is formed from a sheet of material which is unaffected by heat from a hot beverage. Alternatively, embodiments comprising a thermoplastic extruded form comprising a profile to maintain rigidity when used in a hot beverage are within the spirit and scope of the present disclosure. Further examples of containers for beverage additives include tubes or containers constructed from a thin-walled and non-rigid material such as a thin plastic film or paper-based material wherein the container relies on the contents held within to offer rigidity to the container. Once the additive is emptied from the container, the container loses rigidity and cannot be used as a stirring implement.

It is an aspect of certain embodiments to provide a planar surface wherein printed matter can be placed thereon. The printed matter can provide valuable information such as the contents of a container, brand specific information, while preventing the rolling of a tubular container when placed on a planar surface.

A further problem with prior art solutions for single-serving containers such as those for sugar or creamer result in volume wasting forms. For instance, a sugar-bag having a non-rigid paper form results in the sugar to gather toward an edge or toward the center in a bulging pillow-shape. Thus, the stacking of sugar bags results in an increased volume due to the sugar bags not properly nesting with each other. Furthermore, containers such as creamer pods are commonly provided in round single-serving containers. As will be appreciated, round profile containers are inefficient for nesting of uniform container and create approximately 80% wasted space in comparison to a similarly dimensioned cube.

It is a further aspect of the present disclosure to provide a tubular container which is configured to nest with similarly sized and shaped containers to minimize volumetric loss and increase efficiency for packaging purposes. In certain embodiments, as shown, the tubular container comprises a triangular cross-sectional profile which inherently provides an efficient stacking ability. While equilateral triangular profiles are shown, alternate cross-sectional profiles that enable efficiency in packaging are within the spirit and scope of the present disclosure. Increased efficiency of packaging translates into reduced distribution and shipping costs, as well as related emissions. Furthermore, increased efficiency of packaging further translates into reduction of required shelf-space in retail and home environments. Reduction of shelf-space in retail environments, allows for increased stock to be available to a consumer, and reduction of cost for prime shelf-location.

It is an aspect of the present disclosure to provide a tubular container which is configured to be used as a stirring device wherein the action of stirring with the device provides a high level of turbulence when used. Increased turbulence provides more effective mixing between a beverage and an additive. Stirring devices in the prior art which employ a curvilinear or round tubular cross-section results in laminar flow properties around the stirring device. Embodiments disclosed herein employ polygonal shaped tubular cross section to increase turbulence around the tubular container when used as a stirring device. Furthermore, certain embodiments include an opening disposed at an angle between 0-degrees and less than 90-degrees to the tubular cross-section. The angular opening results in additional cross-sectional area for stirring, and allows the user to use the tubular container to scrape the bottom of the container to assist in stirring in solid additives that may have sunk to the bottom of the container.

It is an aspect of the present disclosure to provide a tubular container which can be manufactured from a variety of materials, and in certain embodiments manufactured from a flat sheet material.

It is an aspect of the present disclosure that the tubular container to reduce waste-stream products as related to beverage additive containers. In certain embodiments the tubular container comprises a material which is manufactured from a material which is recyclable, bio-degradable, compostable, or a combination thereof. In certain embodiments the tubular container is constructed of recyclable paper products, compostable paper products, recycled paper products or a combination thereof to reduce creating additional waste as is found with plastic-based beverage-additive containers.

It is a further aspect of certain embodiments of the present disclosure to provide a tubular container wherein a consumer can dispense the substance contained therein directly into their mouth rather than into a beverage. Embodiments of the present disclosure can be used for the containment and dispensing of individual servings of alcoholic shots, workout supplements, candy, medicines, glucose supplements for diabetics, or other substances as desired.

These and other advantages will be apparent from the disclosure of the inventions contained herein. The above-described embodiments, objectives, and configurations are neither complete nor exhaustive. As will be appreciated, other embodiments of the disclosure are possible using, alone or in combination, one or more of the features set forth above or described in detail below. Further, this Summary is neither intended nor should it be construed as being representative of the full extent and scope of the present disclosure. The present disclosure is set forth in various levels of detail in this Summary, as well as in the attached drawings and the detailed description below, and no limitation as to the scope of the present disclosure is intended to either the inclusion or non-inclusion of elements, components, etc. in this Summary.

Additional aspects of the present disclosure will become more readily apparent from the detailed description, particularly when taken together with the drawings, and the claims provided herein.

### BRIEF DESCRIPTION OF THE DRAWINGS

FIG. 1A—A perspective view of certain embodiments of the present disclosure comprising a tubular container

FIG. 1B—A top view of certain embodiments of the present disclosure comprising a tubular container

FIG. 1C—A cross-sectional view of the embodiment shown in FIG. 1B

FIG. 2—A cross-sectional view of the embodiment shown in FIG. 1B, shown in use dispensing a flowable substance

FIG. 3—A front view of certain embodiments comprising a membrane with a tab for removal of the membrane from the tubular container

FIG. 4A—A front-end open view of certain embodiments of the present disclosure comprising a tubular container

FIG. 4B—A back-end view of certain embodiments of the present disclosure comprising a tubular container

FIG. 5A—A side view of certain embodiments of the present disclosure comprising a tubular container

FIG. 5B—A cross-sectional view of the embodiment shown in FIG. 5A

FIG. 5C—A cross-sectional view of the embodiment shown in FIG. 5A

FIG. 6A—A side view of certain embodiments of the present disclosure comprising a tubular container

FIG. 6B—A top view of certain embodiments of the present disclosure comprising a tubular container

FIG. 7—A perspective view of certain embodiments of the present disclosure comprising a tubular container comprising an aperture for mitigating air-lock

FIG. 8—A perspective view of certain embodiments of the present disclosure comprising a tubular container comprising printed matter

FIG. 9A—A first representative cross-section of material used to construct the tubular container in certain embodiments

FIG. 9B—A second representative cross-section of material used to construct the tubular container in certain embodiments

FIG. 9C—A third representative cross-section of material used to construct the tubular container in certain embodiments

FIG. 10A—A top view of certain embodiments of the present disclosure comprising a tubular container

FIG. 10B—A top view certain embodiments comprising a sheet-material which is folded to form a tubular container

FIG. 10C—A top view certain embodiments comprising a sheet-material which is folded to form a tubular container

### DETAILED DESCRIPTION OF VARIOUS EMBODIMENTS

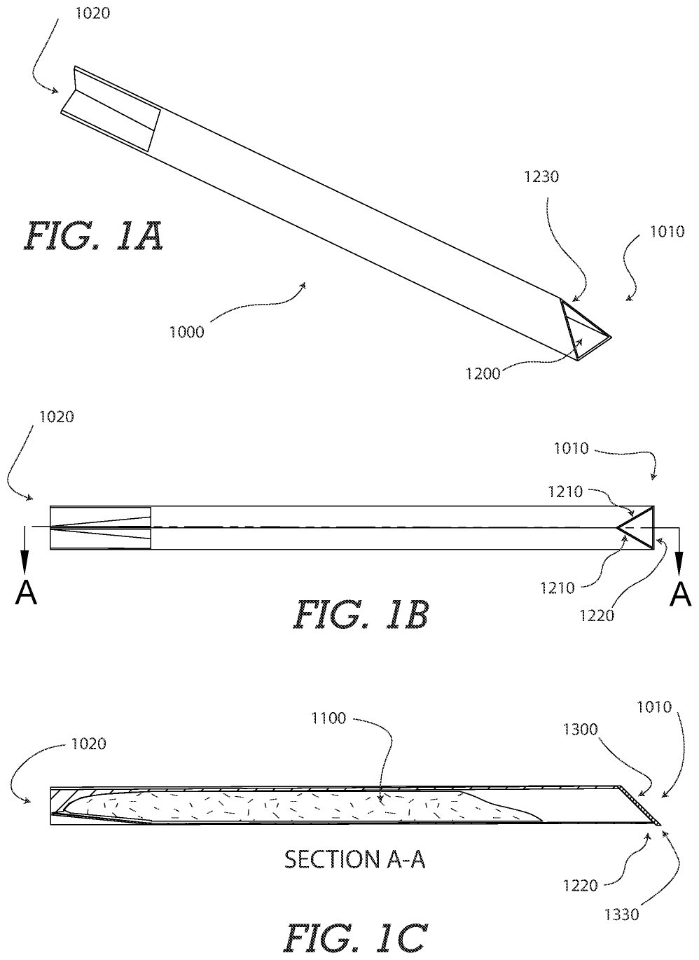

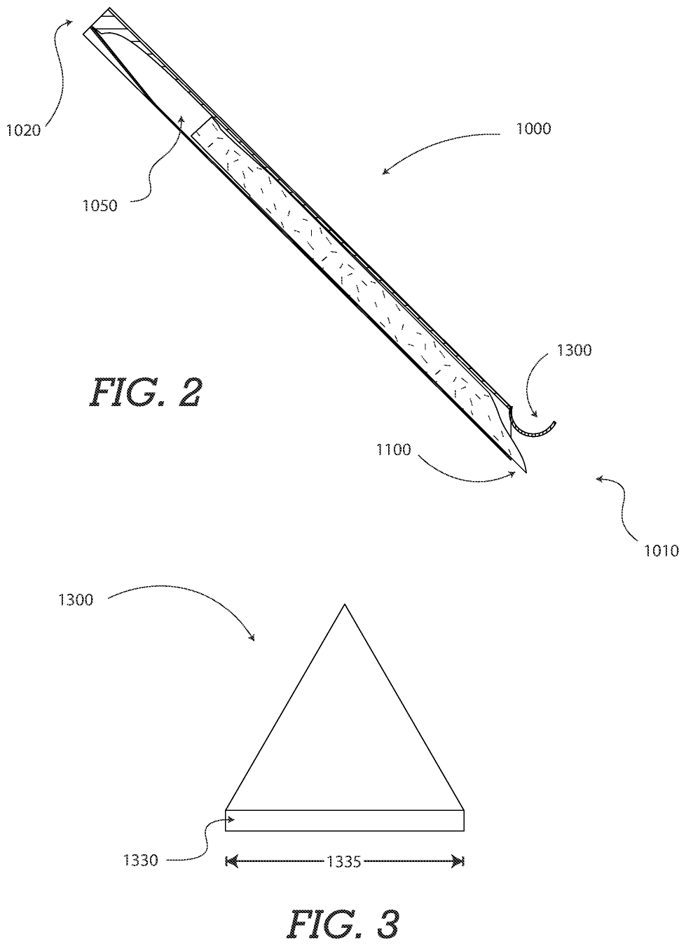

Certain embodiments of the present disclosure, as shown in FIG. 1A—FIG. 3 for instance, comprise a tubular container 1000 configured to hold a flowable substance 1100 therein. In certain embodiments the tubular container 1000 comprises a first end 1010, and a second end 1020. The first end 1010 comprises an opening 1200 wherethrough a flowable substance 1100 contained within the hollow aspect 1050 of the tubular container is dispensed.

In certain embodiments, the first end 1010 is sealed after a flowable substance 1100 is stored within the hollow aspect 1050 of the tubular container. In certain embodiments the first end 1010 is sealed with a membrane 1300 which is interconnected with the first end 1010 of the tubular container to seal the opening 1200 and prevent the passage of the flowable substance 1100 therethrough. The membrane 1300 is removable wherein a user can remove the membrane 1300 to allow the dispensing of the flowable substance 1100 contained within the tubular container 1000. In certain embodiments the membrane 1300 comprises a tab 1330 which is adapted for a user to grab or pinch the tab 1330 to enable the user to peel or otherwise pull to disconnect or remove the membrane from the first end of the tubular container, thereby allowing the dispensing of the flowable substance 1100 contained therein. While it is preferred to interconnect a membrane 1300 with the perimeter 1230 of the opening of the first end, alternative strategies of sealing the first end are within the spirit and scope of the present disclosure. Embodiments including the use of sealing strategies such as those found in U.S. Pat. No. 2,227,341 to Greenwood (“Greenwood”), U.S. Pat. No. 6,638,549 to Lloyd (“Lloyd”), and U.S. Pat. No. 8,910,828 to Kanderka, et al. (“Kanderka”) are within the spirit and scope of the present disclosure. The contents of the forementioned patent publications are each incorporated herein in their entireties for all purposes.

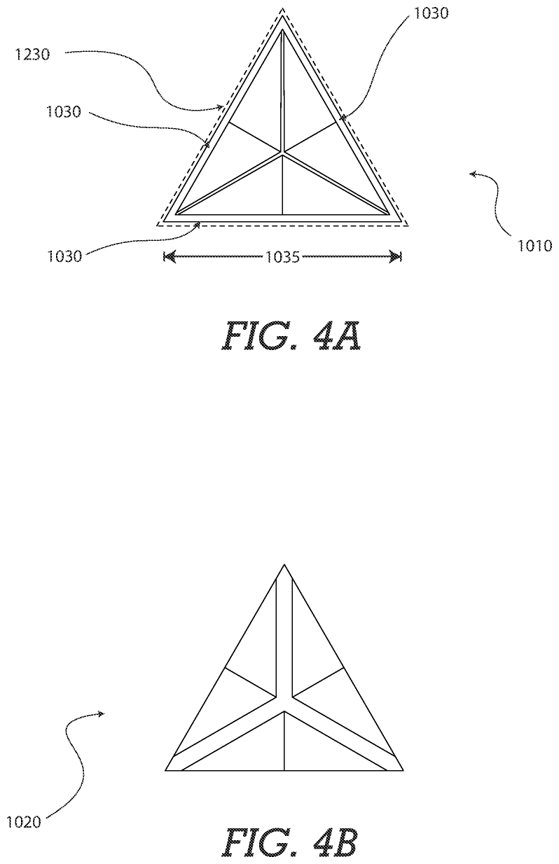

In certain embodiments, as shown in FIG. 1A—FIG. 4A for instance, membrane 1300 is interconnected with the opening 1200 wherein the tab 1330 spans the width 1035 of a side 1030 of the tubular container. Thus, maximizing the width of the tab 1335 and increasing the ease of grasping the tab 1330 and pulling the tab 1330 to remove the membrane 1330 and allow the dispensing of the flowable substance 1100 held within the tubular container 1000. In certain embodiments it is preferred that the tab 1330 overhangs the distal end 1220 of the opening, however alternative embodiments wherein the tab 1330 overhangs a lateral edge 1210 of the opening, or alternate aspects of the opening 1200 are within the spirit and scope of the present disclosure.

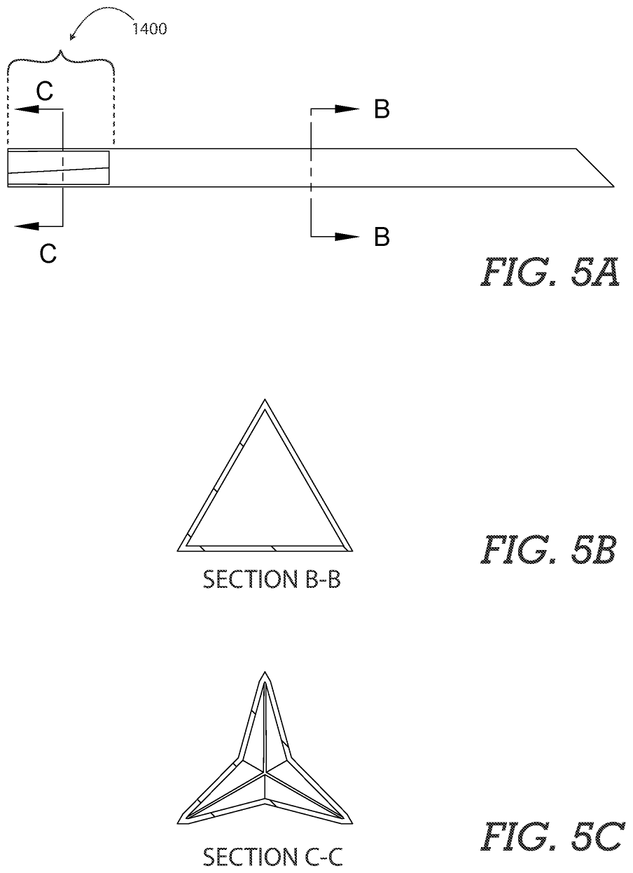

In certain embodiments, as shown in FIG. 4B—FIG. 5C for instance, the second end 1020 is crimped closed wherein a cross section of the crimped portion 1400 resembles a simple star shape. A “simple star shape” as referred to herein refers to a concave isotoxal star shape. An isotoxal star shape is commonly understood as a regular non-convex polygon, also referred to as a “star polygon”, wherein the non-perimetral internal intersecting lines are removed. In certain embodiments the tubular container 1000 comprises a cross section having a triangular shape (FIG. 5B). In certain embodiments the tubular container 1000 comprises a cross sectional profile having an equilateral triangle shape. Accordingly, the crimped portion 1400 comprises a simple three-point star shape (FIG. 5C). Similarly, in embodiments wherein the tubular container comprises a cross section having a square shape, the crimped portion 1400 would accordingly comprise a simple 4-point star shape. While triangularly shaped cross-sections are discussed and shown herein, embodiments comprising alternate shapes are within the spirit and scope of the present disclosure.

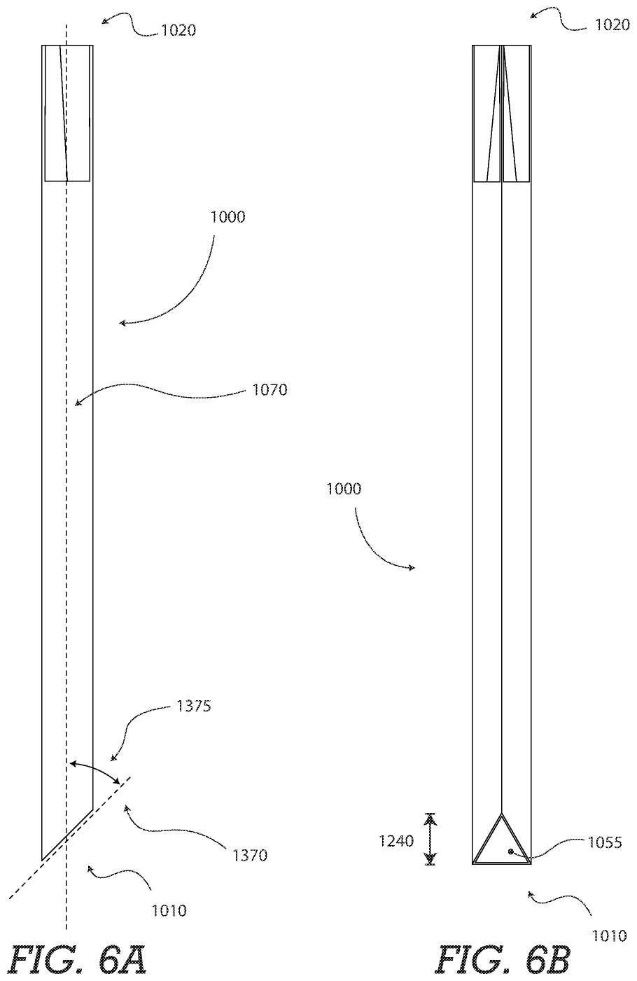

In certain embodiments, as shown in FIG. 6A—FIG. 6B for instance, it may be desired for the opening 1200 to be defined by a plane 1370 which transects the tubular container at a transection angle 1375 to a longitudinal axis 1070 of the tubular container. In certain embodiments the planar transection is disposed at an angle between 0-degrees and less than 90-degrees from the longitudinal axis of the tubular container. In certain embodiments it may be desired that the planar transection angle to have a value between 30-degrees and 60-degrees from the longitudinal axis of the tubular container. In further embodiments still, it may be desired for the planar transection angle to be 45-degrees.

As the angle of the planar transection approaches 0-degrees, the effective length 1240 of the opening elongates, and thereby exposes a greater amount of internal surface area 1055 to assist in stirring actions. Furthermore, the increased internal surface area increases turbulence for more effective mixing of the substance into a target beverage or liquid.

The inclusion of acute internal angles in relation to the cross-section of the tubular container further assists in creating turbulence for more effective mixing of the substance into a target beverage or liquid. Accordingly, it may be desired in certain embodiments for the tubular container to have a polygonal cross section having acute internal angles such as a triangle, or simple star shape.

Furthermore, as the angle of the planar transection which defines the opening of the tubular container approaches 0-degrees increases the effective area of the opening and thereby mitigates an airlock or vacuum effect which may prevent the dispensing of the flowable substance contained within the tubular container.

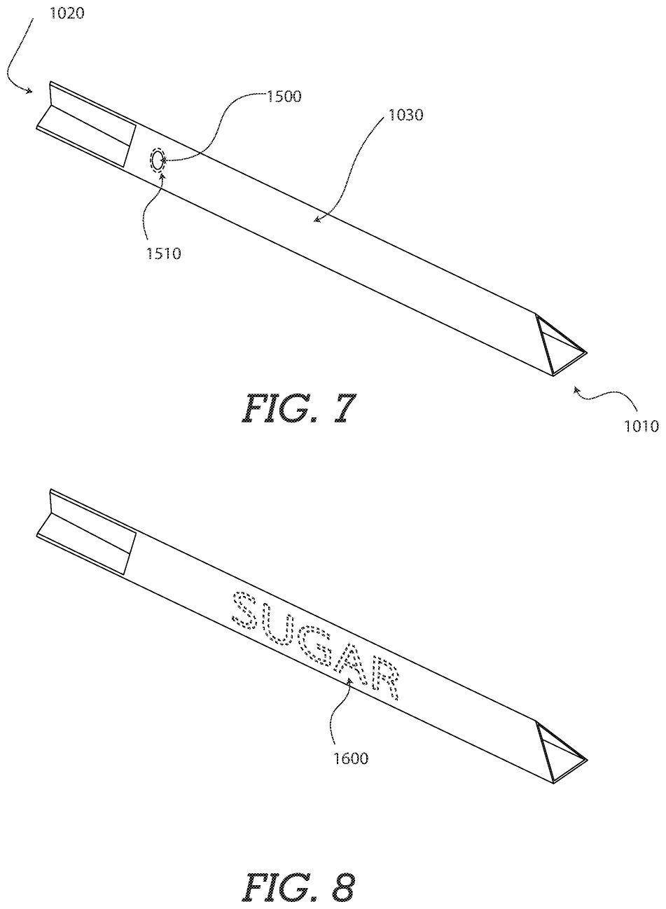

In certain embodiments, shown in FIG. 7 for instance, the tubular container comprises an aperture 1500 proximate to the second end 1020. The aperture 1500 is sealed wherein the removal of the seal 1510 opens the aperture and thereby mitigates an airlock or vacuum effect which may prevent the dispensing of the flowable substance 1100 contained within the tubular container 1000. In certain embodiments, the seal 1510 comprises a membrane configured to cover the aperture at the second end of the tubular container wherein the membrane is configured to be removed to expose the aperture 1500 and allow airflow therethrough to mitigate an airlock or vacuum effect which prevents the dispensing of the flowable substance. The mitigation of an airlock or vacuum effect provides an added benefit in the use of the tubular container as a stirring device as it prevents the retention of a liquid (e.g., coffee, tea, etc) within the tube during or following the use of the tubular container as a stirring implement.

In certain embodiments of the present disclosure, as shown in FIG. 8 for instance, the tubular container comprises printed matter 1600 on an external surface. While it may be preferred in certain embodiments for the printed matter to be placed on a planar external surface as shown, printed matter on a curved external surface is also within the spirit and scope of the present disclosure. “Printed matter” as used herein surrounds the written word such as a brand name or instructions, contents, nutritional information, branding, icons, imagery, or other informative matter which can be printed, stamped, embossed, adhered such as in the case of a sticker, or otherwise displayed on an external surface of the present disclosure.

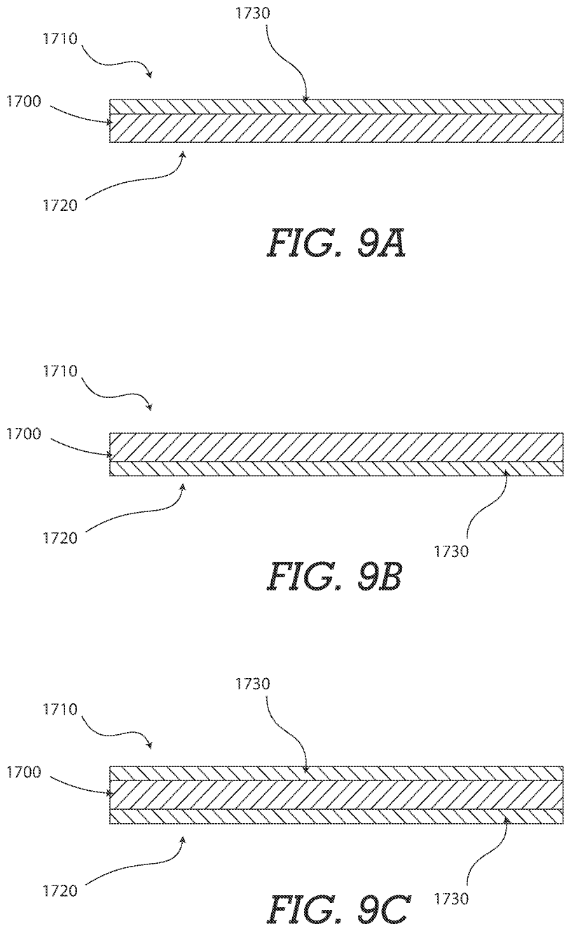

In certain embodiments, as shown in FIG. 9A—FIG. 9C for instance, the tubular container comprises a material 1700 which is recycled, compostable, biodegradable, or a combination thereof. In certain embodiments the material of the tubular container comprises a hydrophobic characteristic. In certain embodiments the tubular container comprises a material such as paper or paperboard with a hydrophobic coating applied to at least the inner surface 1710 of the tubular container, or the outer surface 1720 of the tubular container. A hydrophobic coating as disclosed herein surrounding the use of material treatment such as a wax application to the material, or a hydrophobic layer 1730 applied to the material such as a layer of polyethylene. In certain embodiments it may be desired for the inner surface 1710 to comprise hydrophobic properties, while in alternate embodiments it may be desired for the outer surface 1720 of the tubular container to comprise hydrophobic properties. Furthermore, it may be desired for the outer surface 1720 and the inner surface 1710 of the tubular container to comprise hydrophobic properties. Further still, it may be desired that the tubular container comprises a material which is naturally hydrophobic such as polyethylene, but not limited thereto.

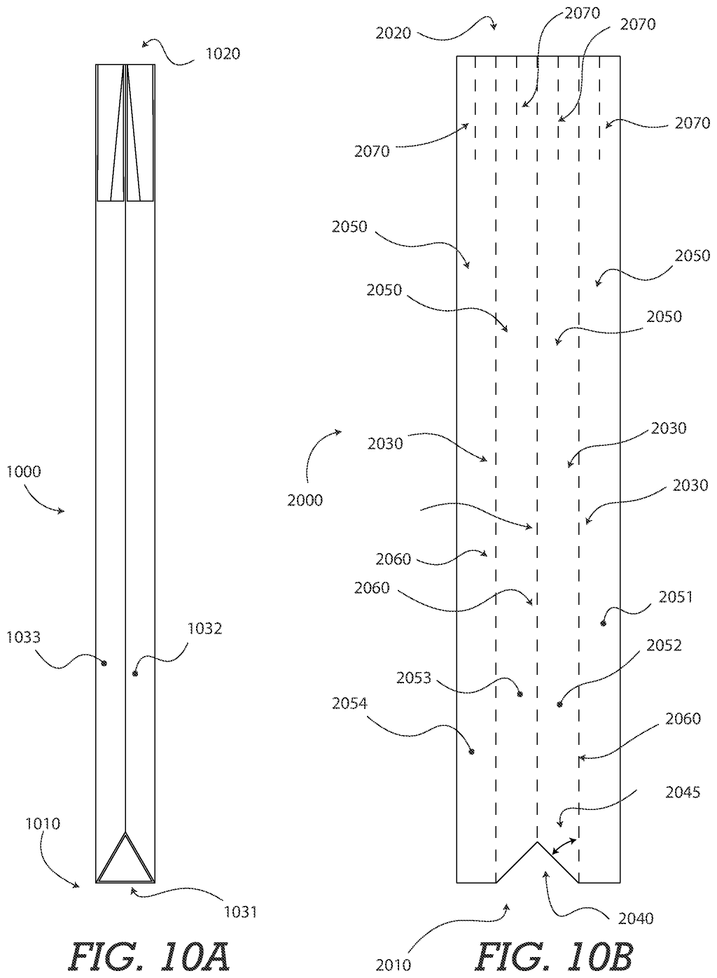

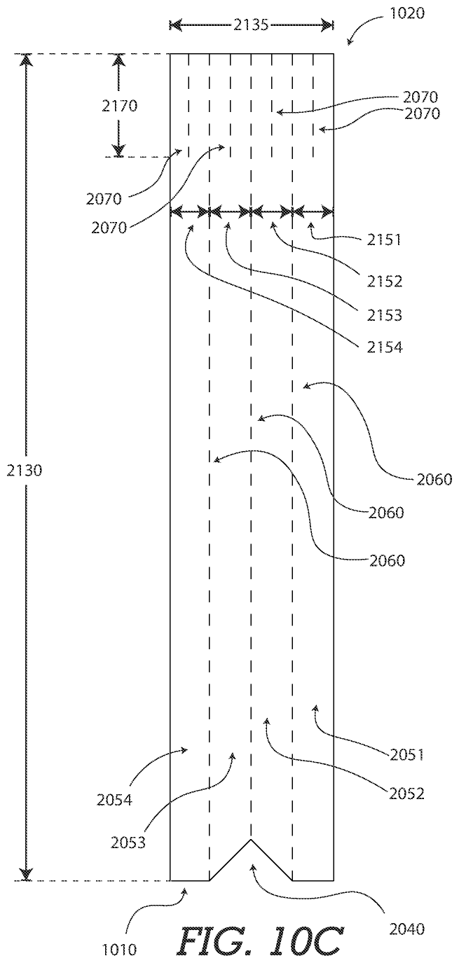

In certain embodiments, as shown in FIG. 10A—FIG. 10B for instance, a tubular container 1000 is constructed from sheet-material 2000. It may be desired in certain embodiments for the tubular container 1000 to be constructed from a continuous piece of sheet-material 2000 wherein the sheet is folded along longitudinal crease lines 2060 to create the tubular form of the tubular container. The first end 2010 of the sheet comprises a notch 2040 cut therein. The notch 2040 comprises a triangular form wherein the angle 2045 of the notch is equal to the transection angle 1375 as shown in FIG. 6A and wherein the notch is in at least two longitudinal segments 2050. Where the tubular container comprises (n) sides, the sheet form comprises (n+1) longitudinal segments 2050 which are folded along (n) longitudinal crease lines 2060 which extend from the first end 2010 to the second end 2020 of the sheet-material 2000. For instance, as shown, a triangular tubular container has 3 sides—therefore the sheet comprises 4 longitudinal segments 2050 folded along 3 longitudinal crease lines 2060. A first longitudinal segment 2051, a second longitudinal segment 2052, and a third longitudinal segment 2053 produce the first side 1031, the second side 1032, and the third side 1033 of the longitudinal container. The fourth longitudinal segment 2054, which is the last longitudinal segment in such embodiments, is overlappingly interconnected with the first longitudinal segment 2051 to secure the form and produce a sealed tubular container 1000. The second end 1020 of the tubular container is then crimped closed wherein the sides 1030 of the second end 1020 of the tubular container are further creased and contracted inward along crimp lines 2070 until the sides 1030 of the tubular container are interconnected to each other. As shown, the crimp lines 2070 of certain embodiments are interspaced between the longitudinal crease lines 2060. The crimp lines 2070 as shown are parallel to the longitudinal crease lines 2060, however the crimp lines 2070 are not limited to being parallel to the longitudinal crease lines 2060. Embodiments as shown present the crimp lines 2070 as spaced equidistantly from adjacent longitudinal crease lines 2060, however the crimp lines 2070 are not limited to being spaced equidistantly from adjacent longitudinal crease lines 2060. In certain embodiments, the interconnection of sheet-material 2000 comprising the walls of the tubular container 1000 are interconnected using bonding strategies including, but not limited to the use of adhesive, heat welding, and sonic welding.

In certain embodiments, as shown in FIG. 10A—FIG. 10C for example, the sheet-material 2000 comprises a length 2130 and a width 2135. The first longitudinal segment 2051 comprises a width 2151 equal to the width 2152 of the second longitudinal segment and the width 2153 of the third longitudinal segment. In certain embodiments however, it may be desired for the width 2152 of the second longitudinal segment and the width 2153 of the third longitudinal segment to be different than the width 2151 of the first longitudinal segment. In certain embodiments it may be desired for the fourth longitudinal segment 2054 to have a width 2154 of equal or less than the width 2151 of the first longitudinal segments. The crease lines 2030 extend from the first end 2010 of the sheet-material to the second end 2020 of the sheet-material, and the crimp lines 2070 have a length 2170 extending partially from the second end 2020 toward the first end 2010 of the sheet material.

In certain embodiments, the length 2130 of the sheet material is 200 mm, and the width 2135 of the sheet material is 39.5 mm. Furthermore, in certain embodiments the widths 2151, 2152, 2153 of the first, second, and third longitudinal segments are 10 mm, and the width 2154 of the fourth longitudinal segment is 9.5 mm. Further still, in certain embodiments, the crimp lines comprise a length of 25 mm. Additionally, in certain embodiments it may be desired for the angle 2045 of the notch to equal 45-degrees.

While various embodiments of the present disclosure have been described in detail, it is apparent that modifications and alterations of those embodiments will occur to those skilled in the art. However, it is to be expressly understood that such modifications and alterations are within the scope and spirit of the present disclosure. Further, the disclosures described herein are capable of other embodiments and of being practiced or of being carried out in various ways. In addition, it is to be understood that the phraseology and terminology used herein is for the purposes of description and should not be regarded as limiting. The use of “including.” “comprising.” or “adding” and variations thereof herein are meant to encompass the items listed thereafter and equivalents thereof, as well as, additional items.

What is claimed is:

1. A dispensing and stirring device comprising:
a tubular container comprising a cross-sectional profile having a regular polygonal shape;
a first end of the tubular container comprises an opening adapted for dispensing a flowable substance contained within the tubular container;
the opening is sealed by a membrane comprising a tab, wherein pulling of the tab removes the membrane;
the tubular container further comprising a closed second end, wherein the second end is crimped closed and comprises a simple star shaped cross-sectional profile; and
the tubular container adapted to contain a flowable substance therein, wherein removal of the membrane allows the dispensing of the flowable substance.

2. The dispensing and stirring device of claim 1, wherein the opening is disposed at an angle greater than 0-degrees and less than 90-degree to a longitudinal axis.

3. The dispensing and stirring device of claim 2, wherein the opening is defined by a plane which transects the longitudinal axis at the angle.

4. The dispensing and stirring device of claim 3, wherein the angle is 45-degrees.

5. The dispensing and stirring device of claim 1, wherein the tab overhangs a distal end of the opening.

6. The dispensing and stirring device of claim 5, wherein the tab comprises a width which is equal to or less than a width of a side of the regular polygonal shape.

7. The dispensing and stirring device of claim 1, wherein the regular polygonal shape comprises an equilateral triangle.

8. The dispensing and stirring device of claim 7, wherein the simple star shaped cross-sectional profile comprises a simple three-point star shaped cross-sectional profile.

9. The dispensing and stirring device of claim 1, wherein the tubular container is constructed from a paper-based material.

10. The dispensing and stirring device of claim 9, wherein at least one of an inner surface of the tubular container and an outer surface of the tubular container, comprise a hydrophobic property.

11. The dispensing and stirring device of claim 10, wherein the hydrophobic property comprises a hydrophobic coating on the at least one of the inner surface of the tubular container and the outer surface of the tubular container.

12. The dispensing and stirring device of claim 1, wherein the tubular container is constructed from a continuous piece of sheet material, wherein the sheet material comprises a plurality of longitudinal segments which are folded along a plurality of longitudinal crease lines.

13. The dispensing and stirring device of claim 12, wherein a first longitudinal segment is configured to be interconnected to a last longitudinal segment.

14. The dispensing and stirring device of claim 12, wherein the cross-sectional profile of the tubular container comprises (n) sides; and
the sheet material comprises (n+1) longitudinal segments, which are folded along (n) longitudinal crease lines.

15. The dispensing and stirring device of claim 14, wherein (n)=3.

16. The dispensing and stirring device of claim 15, wherein a first longitudinal segment is configured to overlappingly interconnect with a fourth longitudinal segment.

17. The dispensing and stirring device of claim 14, wherein the second end of the tubular container is crimped along crimp lines which are interspaced between the longitudinal crease lines.

18. The dispensing and stirring device of claim 1, wherein the tubular container further comprises an aperture through a side of the tubular container, wherein the aperture comprises a seal configured to cover the aperture.

19. The dispensing and stirring device of claim 18, wherein the seal comprises a membrane configured to be removed to expose the aperture and allow airflow therethrough.

20. The dispensing and stirring device of claim 18, wherein the aperture is located proximate to the second end of the tubular container.
